(19) United States
(12) Patent Application Publication
(10) Pub. No.: US 2012/0307376 A1
(43) Pub. Date: Dec. 6, 2012

(54) ZOOM LENS AND PHOTOGRAPHING APPARATUS HAVING THE SAME

(75) Inventor: Tsuyoshi Kakimoto, Suwon-si (KR)

(73) Assignee: Samsung Electronics Co., Ltd., Suwon-si (KR)

(21) Appl. No.: 13/485,097

(22) Filed: May 31, 2012

(30) Foreign Application Priority Data
Jun. 1, 2011 (KR) 10-2011-0052999

(51) Int. Cl. G02B 15/14

(52) U.S. Cl. 359/687

(57) ABSTRACT

A zoom lens and a photographing apparatus having the same. The zoom lens includes a first lens group having a positive refractive power, a second lens group having a negative refractive power, a third lens group having a positive refractive power, and a fourth lens group having a positive refractive power that are sequentially arranged from an object side to an image plane side. An interval between the lens groups adjacent to each other varies when the zoom lens zooms from a wide angle position to a telephoto position. The zoom lens satisfies the following inequality:

1.8<|β_{3T}/β_{3W}|<2.2 <Formula>
where β_{3T} denotes the magnification of the third lens group at the telephoto position, and β_{3W} denotes the magnification of the third lens group at the wide angle position.

### CROSS-REFERENCE TO RELATED PATENT APPLICATION

This application claims the benefit of Korean Patent Application No. 10-2011-0052999, filed on Jun. 1, 2011, in the Korean Intellectual Property Office, the disclosure of which is incorporated herein in its entirety by reference.

### BACKGROUND

1. Field of the Invention

The invention relates to a zoom lens for a photographing apparatus which is adopted in a subminiature digital camera, a digital video camera, a portable phone, a personal digital assistant (PDA), or the like, and a photographing apparatus having the same.

2. Description of the Related Art

An image formation optical instrument such as a digital camera or digital camcorder using an image pickup device such as a charge-coupled device (CCD) or a complementary metal-oxide semiconductor (CMOS) has been quickly extended and propagated in recent years.

Also, as users of the digital camera increase in number and are increasingly specialized, a photographing apparatus which can realize superior performance, high magnification, and portable compact size is increasingly required. Thus, in a zoom lens adopted for the digital camera, the superior performance, high magnification, and miniaturization are also required.

In general, a four-group type zoom lens may realize high magnification equal to or greater than about 5×. In addition, since a four-group type zoom lens has a relatively small size, the four-group type zoom lens is widely adopted in digital cameras.

Thus, design plans with respect to various four-group type zoom lenses are proposed. However, aberration involved in zooming increases in the realization of high magnification. Thus, it is difficult to realize high optical performance over the entire region. Also, it is difficult to correct the aberration and reduce a size of an optical system at the same time because a thickness of the lens is thicker for correcting the aberration.

### SUMMARY

Provided is a zoom lens having high magnification, high optical performance, brightness and miniaturization, and a photographing apparatus having the same.

According to an aspect of the invention, there is provided a zoom lens including: a first lens group having a positive refractive power, a second lens group having a negative refractive power, a third lens group having a positive refractive power, and a fourth lens group having a positive refractive power that are sequentially arranged from an object side to an image plane side, wherein the interval between the lens groups adjacent to each other varies when the zoom lens zooms from a wide angle position to a telephoto position, and wherein the zoom lens satisfies the following inequality:

1.8<|β_{3T}/β_{3W}|<2.2

where β_{3T} denotes the magnification of the third lens group at the telephoto position, and β_{3W} denotes the magnification of the third lens group at the wide angle position.

The zoom lens may satisfy the following inequality:

0.8<T₁/T₃<1.2

where T₁ denotes the distance the first lens group moves in an optical axis direction when the zoom lens zooms from the wide angle position to the telephoto position, and T₃ denotes the distance the third lens group moves in an optical axis direction when the zoom lens zooms from the wide angle position to the telephoto position.

The first lens group may include a negative lens and a positive lens which are sequentially arranged from the object side to the image plane side, and the positive lens has at least one aspherical surface.

The second lens group may include two negative lenses and a positive lens which are sequentially arranged from the object side to the image plane side, and the negative lens of the object side of the negative lenses has at least one aspherical surface.

The zoom lens may satisfy the following inequality:

1.2<|f₂/f_{W}|<1.4

where f₂ denotes the focal length of the second lens group, and f_{w} denotes the total focal length at the wide angle position.

The zoom lens may satisfy the following inequality:

9<fₜ/f_{w}<12

where fₜ denotes the total focal length at the telephoto position, and f_{w} denotes the total focal length at the wide angle position.

The third lens group may include a positive lens having at least one aspherical surface.

The third lens group may include at least one doublet lens comprising a positive lens and a negative lens.

The fourth lens group may include a positive lens having at least one aspherical surface.

The positive lens may be formed of plastic.

The fourth lens group may perform focusing.

The third lens group may be moved vertically with respect to an optical axis to perform image blurring compensation.

According to another aspect of the invention, there is provided a photographing apparatus including: a zoom lens; and an image pickup device receiving an image formed through the zoom lens, wherein the zoom lens comprises: a first lens group having a positive refractive power, a second lens group having a negative refractive power, a third lens group having a positive refractive power, and a fourth lens group having a positive refractive power that are sequentially arranged from an object side to an image plane side, wherein an interval between the lens groups adjacent to each other varies when the zoom lens zooms from a wide angle position to a telephoto position, and wherein the zoom lens satisfies the following inequality:

1.8<|β_{3T}/β_{3W}|<2.2

where β_{3T} denotes the magnification of the third lens group at the telephoto position, and β_{3W} denotes the magnification of the third lens group at the wide angle position.

### BRIEF DESCRIPTION OF THE DRAWINGS

The above and other features and advantages of the invention will become more apparent by describing in detail exemplary embodiments thereof with reference to the attached drawings in which:

FIG. 1 is an optical arrangement view of a wide angle, a middle, and a telephoto position of a zoom lens according to an embodiment of the invention.

FIGS. 2A, 2B, and 2C are views illustrating longitudinal spherical aberration, astigmatic field curves, and distortion at the wide angle, the middle, and the telephoto position of the zoom lens according to the first embodiment of the invention, respectively.

FIG. 3 is an optical arrangement view of a wide angle, a middle, and a telephoto position of a zoom lens according to a second embodiment of the invention.

FIGS. 4A, 4B, and 4C are views illustrating longitudinal spherical aberration, astigmatic field curves, and distortion at the wide angle, the middle, and the telephoto position of the zoom lens according to the second embodiment of the invention, respectively.

FIG. 5 is an optical arrangement view of a wide angle, a middle, and a telephoto position of a zoom lens according to a third embodiment of the invention.

FIGS. 6A, 6B, and 6C are views illustrating longitudinal spherical aberration, astigmatic field curves, and distortion at the wide angle, the middle, and the telephoto position of the zoom lens according to the third embodiment of the invention, respectively.

FIG. 7 is a schematic perspective view of a photographing apparatus according to an embodiment of the invention.

### DETAILED DESCRIPTION

Hereinafter, embodiments of the invention will be described in detail with reference to the accompanying drawings. In the drawings, like reference numbers refer to like elements, and also the size of each component may be exaggerated for clarity of illustration. The embodiments described below are just exemplary, and it will be understood that various changes may be made therein.

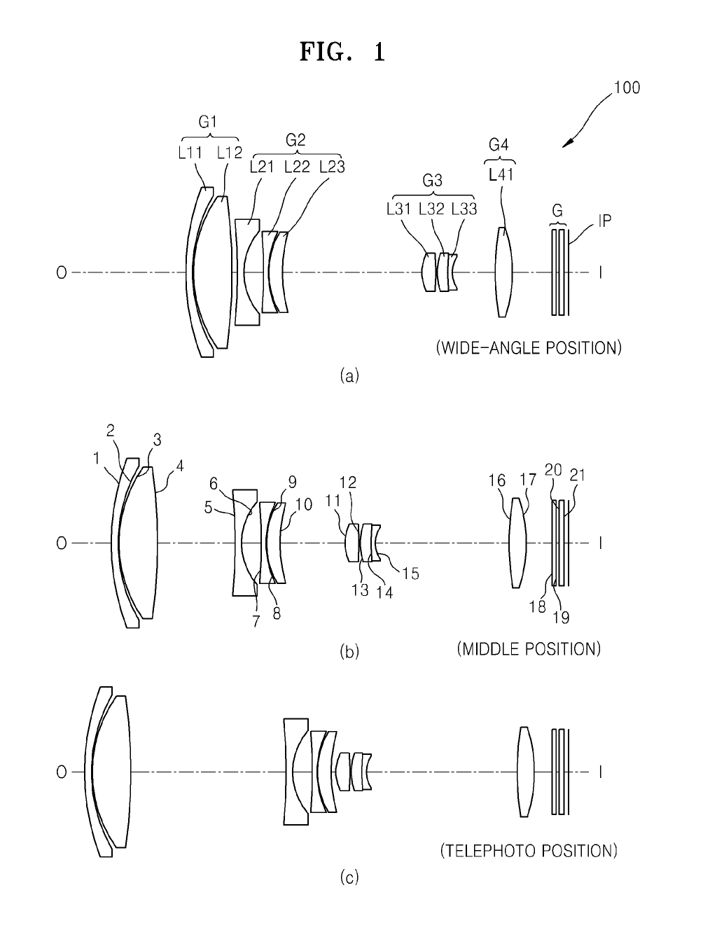

FIGS. 1, 3, and 5 are optical arrangement views of a zoom lens 100 according to embodiments of the invention.

The zoom lens 100 according to the embodiments includes a first lens group G1 having a positive refractive power, a second lens group G2 having a negative refractive power, a third lens group G3 having a positive refractive power, and a fourth lens group G4 having a positive refractive power. Here, the first to fourth lens groups G1 to G4 are sequentially arranged from an object side O to an image plane side I. Also, an optical block G is disposed between the fourth lens group G4 and an image plane IP. When the zoom lens 100 zooms, all intervals among the first to fourth lens groups may vary. Also, zoom magnification and angle of view may vary by the zooming of the zoom lens 100.

The first lens group G1 includes only two lenses, i.e., a first lens L11 having a negative refractive power and a second lens L12 having a positive refractive power, which are sequentially arranged from the object side O. The first lens L11 may have a meniscus shape protruding to the object side O, and the second lens L12 may have at least one aspherical surface. The first lens L11 and the second lens L12 may be provided as separate lenses (i.e., not a doublet lens), so that the second lens L12 may be freely adjusted in refractive power to realize a high magnification. In addition, the second lens L12 may have at least one or more aspherical surfaces to control off-axis aberration.

The second lens group G2 includes three lenses, i.e., a third lens L21 having a negative refractive power, a fourth lens L22 having a negative refractive power, and a fifth lens L23 having a positive refractive power, which are sequentially arranged from the object side O.

The third lens L21 may have one or more aspherical surfaces to easily control aberration.

The third lens group G3 may include only three lenses. For example, the third lens group G3 may include a sixth lens L31 having a positive refractive power, a seventh lens L32 having a positive refractive power, and an eight lens L33 having a negative refractive power, which are sequentially arranged from the object side O.

The third lens group G3 may include an aspherical lens having a positive refractive power. For example, the sixth lens L31 may be an aspherical lens. Thus, it may be possible to correct spherical aberration occurring during zooming and a variation of spherical aberration occurring during the correction of image blurring at the same time. Also, the third lens group G3 may include at least one doublet lens constituted by positive and negative lenses to correct chromatic aberration. For example, a doublet lens in which the seventh lens L32 and the eighth lens L33 are bonded to each other may be provided to correct aberration such as chromatic aberration and reduce the effects of attachment errors during the manufacturing, thereby realizing stable optical quality, simplified constitution, and miniaturization.

The third lens group G3 may be vertically moved with respect to an optical axis to shift an image formed on the image plane IP, thereby correcting the image blurring due to shaky hands. Spherical aberration, and eccentric coma aberration occur in a central portion of a screen and the curvature of an image plane occur on peripheral portions of the screen when the shift lens group G3 is vertically moved with respect to the optical axis.

Thus, spherical aberration, and Petzval sum need to be compensated when the lens G3 is shifted for the image blurring compensation. The curvature of an image plane may be restrained through the correction of the Petzval sum.

Also, since the third lens group G3 performs the hand shaking compensation, an optical component such as a prism or a lens group for preventing vibration is not additionally required. Thus, this reduces the size of the overall optical system.

The fourth lens group G4 may include a ninth lens L41 having a positive refractive power. The ninth lens L41 may be formed of plastic, so that the ninth lens L41 may be more easily made in aspherical design to effectively correct the coma aberration and astigmatic aberration, thereby reducing cost.

The optical block G may be an optical filter such as a low pass filter (LPF), a faceplate, and an infrared cut filter.

The zoom lens 100 according to the embodiments of the invention may satisfy the following Inequality 1.

1.8<|β_{3T}/β_{3W}|<2.2 (1)

where β_{3T} denotes the magnification of the third lens group G3 at the telephoto position, and β_{3W} denotes the magnification of the third lens group G3 at the wide angle position.

Inequality 1 defines a zoom ratio of the third lens group G3. When the zoom ratio is equal to or less than the lower limit of Inequality 1, the zoom ratio of the third lens group G3 is decreased and it may be difficult to realize the high magnification of the zoom lens. Also, when the zoom ratio is equal to or greater than the upper limit of Inequality 1, the zoom ratio of the third lens group G3 and it may be difficult to correct aberration of the third lens group G3. Thus, Inequality 1 may be satisfied to optimize the zooming and a variation of aberration due to the zooming may be minimized and a small-sized optical system may be realized.

The zoom lens 100 according to the embodiments of the invention may also satisfy the following Inequality 2.

0.8<T₁/T₃<1.2 (2)

where T₁ denotes the movement distance of the first lens group G1 in an optical axis direction when the zoom lens zooms from the wide angle position to the telephoto position, and T₃ denotes the movement distance of the third lens group G3 in an optical axis direction when the zoom lens zooms from the wide angle position to the telephoto position.

Inequality 2 defines the movement amount of each lens group during zooming. When the movement amount is equal to or less than the lower limit of Inequality 2, the movement distance of the third lens group G3 is increased. Thus, since an optical full length at the wide angle position is increased and a length of a direction perpendicular to the optical axis is also increased, it is disadvantageous to realize miniaturization of the optical system. Also, when the movement amount is equal to or greater than the upper limit of Inequality 2, the movement distance of the first lens group G1 is increased and a distance between the first lens group G1 and the second lens group G2 is increased. Thus, since an optical full length is increased and a length of a direction perpendicular to the optical axis is increased, it is disadvantageous to realize miniaturization of the optical system.

The zoom lens 100 according to the embodiments of the invention may also satisfy the following inequality 3.

1.2<|f₂/f_{W}|<1.4 (3)

where f₂ denotes the focal length of the second lens group G2, and f_{w} denotes the total focal length at the wide angle position.

Inequality 3 defines the ratio of the focal length of the second lens group G2 to the focal length of the total optical system at the wide angle position. When the ratio of the focal length is equal to or greater than the upper limit of Inequality 3, the refractive power of the second lens group G2 is reduced. Thus, it is difficult to realize high magnification. Also, to realize high magnification, since the movement amount of the second lens group G2 is increased, the optical system is increased in total length. Therefore, it is disadvantageous to realize miniaturization of the optical system. Also, when the ratio of the focal length is equal to or less than the lower limit of Inequality 3, the focal length of the second lens group G2 is reduced. Thus, it is difficult to correct aberration, i.e., distortion aberration in the entire region of the zooming. Therefore, it may be difficult to obtain high optical performance.

The zoom lens 100 according to the embodiments of the invention may also satisfy the following inequality 4.

9<fₜ/f_{w}<12 (4)

where fₜ denotes the total focal length at the telephoto position, and f_{w} denotes the total focal length at the wide angle position.

When the ratio of the focal length is equal to or greater than the upper limit of Inequality 4, optical performance is deteriorated. Thus, since the total focal length at the telephoto position is increased, it is difficult to realize miniaturization of the optical system. Also, when the ratio of the focal length is equal to or less than the lower limit of Inequality 4, it is difficult to sufficiently realize the high magnification, the miniaturization, and high optical performance.

The zoom lens according to the invention which satisfies the above conditions may be corrected in aberration due to the zooming while realizing high magnification. Also, high optical performance may be realized over the entire region from the wide angle position to the telephoto position. In addition, peripheral illumination may be sufficiently secured to obtain a bright view and the curvature of image plane may be corrected. Also, since the total length is reduced, it is advantageous to realize miniaturization of the optical system

Hereinafter, each of lens groups will be described in detail with reference to lens data.

The aspherical surface ASP according to the embodiments of the invention will be defined as following Equation 5.

$$z = \frac{{ch}^{2}}{1 + \sqrt{1 - ( 1 + K ) {c}^{2} {h}^{2}}} + {Ah}^{4} + {Bh}^{6} + {Ch}^{8} + {Dh}^{10} \qquad ( 5 )$$

where z denotes the distance from the vertex of a lens in the optical axis direction, h denotes the distance in a direction perpendicular to the optical axis direction, K denotes a conic constant, A, B, C, and D denote aspherical coefficients, and c denotes a reciprocal (1/R) of the radius of curvature at the lens apex.

In lens data, Fno denotes an F-number, f denotes a total focal length [mm], ω denotes a half angle [°] of view, and D1, D2, D3, and D4 denote variable distances [mm] between lenses.

Also, R denotes the radius of curvature [mm] of each lens surface (however, if R denotes ∞, the surface is a plane), D denotes the distance [mm] between lens surfaces in an optical axis direction, Nd denotes the refractive index of each lens, and vd denotes an Abbe number of each lens.

### First Embodiment

FIG. 1 is an optical arrangement view of a zoom lens according to a first embodiment of the invention. The first lens group G1 includes the first lens L11 that is a negative lens having a meniscus shape and the positive lens L12 having an aspherical surface. The second lens group G2 includes a negative lens L21 having an aspherical surface, the negative lens L22, and the positive lens L23. The third lens group G3 includes the positive lens L31 having an aspherical surface and a doublet lens in which the positive lens L32 and the negative lens L33 are bonded to each other. The fourth lens group G4 includes the positive lens L41. The optical block G is disposed between the fourth lens group G4 and the image plane IP.

FIG. 1A shows a lens at the wide angle position, FIG. 1B shows a lens at the middle position, and FIG. 1C shows a lens at the telephoto position. Although reference numerals for each of the lens surfaces are illustrated in FIG. 1, the reference numerals for each of the lens surfaces may be omitted in other drawings related to other embodiment.

In tables below, during zooming according to the first embodiment, an F-number Fno, a focal length f, a half angle ω, and a variable distance D between lenses will be provided.

TABLE 1

| | Wide angle | Middle | Telephoto |
|---|---|---|---|
| Fno | 3.40 | 5.43 | 5.83 |
| f | 5.01 | 16.52 | 47.16 |
| ω | 38.24 | 13.45 | 4.79 |
| D1 | 0.52 | 7.53 | 15.05 |
| D2 | 13.61 | 6.37 | 0.50 |
| D3 | 4.16 | 13.01 | 14.70 |
| D4 | 3.97 | 2.61 | 1.68 |

Table 2 below shows design data according to the first embodiment.

TABLE 2

| Lens surface | R | D | Nd | νd |
|---|---|---|---|---|
| 1 | 24.522 | 0.60 | 1.84666 | 23.78 |
| 2 | 15.524 | 0.10 | | |
| 3* | 13.100 | 3.70 | 1.58313 | 59.04 |
| 4* | −53.659 | D1 | | |
| 5* | −200.000 | 0.70 | 1.85066 | 40.43 |
| 6* | 6.072 | 1.81 | | |
| 7 | −76.550 | 0.50 | 1.59282 | 68.62 |
| 8 | 9.234 | 0.10 | | |
| 9 | 7.617 | 1.24 | 2.00272 | 19.32 |
| 10 | 15.239 | D2 | | |
| 11* | 4.580 | 1.40 | 1.60606 | 54.97 |
| 12* | −20.756 | 0.10 | | |
| 13 | 5.287 | 1.05 | 1.59282 | 68.62 |
| 14 | 18.823 | 0.40 | 1.72825 | 28.32 |
| 15 | 3.002 | D3 | | |
| 16* | 21.475 | 1.66 | 1.54410 | 56.11 |
| 17* | −18.156 | D4 | | |
| 18 | infinity | 0.30 | 1.51680 | 64.20 |
| 19 | infinity | 0.30 | | |
| 20 | infinity | 0.50 | 1.51680 | 64.20 |
| 21 | infinity | | | |

In Table 2, * denotes an aspherical surface. Table 3 below shows aspherical coefficients according to the first embodiment. In values of the aspherical coefficients, E-m (m denotes a constant) denotes ×10^{-m}.

TABLE 3

| Lens surface | k | A | B | C | D |
|---|---|---|---|---|---|
| 3 | 0.00000E+00 | −2.05555E−05 | −1.09495E−07 | −4.80715E−10 | 0.00000E+00 |
| 4 | 1.00000E+00 | 1.03319E−05 | 0.00000E+00 | 0.00000E+00 | 0.00000E+00 |
| 5 | −1.00000E+00 | −8.14911E−04 | 3.55480E−05 | −6.00197E−07 | 2.54245E−09 |
| 6 | −9.40782E−01 | −4.12151E−04 | 3.14945E−05 | 8.57894E−07 | 0.00000E+00 |
| 11 | −1.09550E+00 | 6.03617E−04 | −7.45180E−06 | 0.00000E+00 | 0.00000E+00 |
| 12 | 0.00000E+00 | 6.07270E−04 | −1.65221E−05 | 0.00000E+00 | 0.00000E+00 |
| 16 | 2.63297E+00 | 7.55406E−04 | −1.30509E−04 | 8.19579E−06 | −2.21549E−07 |
| 17 | −8.03435E+01 | −4.72659E−04 | −8.74543E−05 | 6.58306E−06 | −1.85337E−07 |

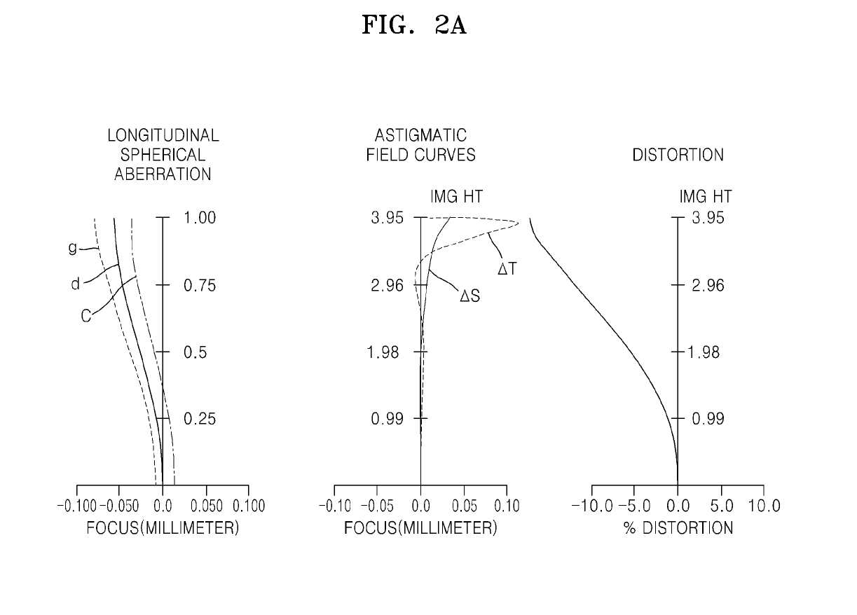

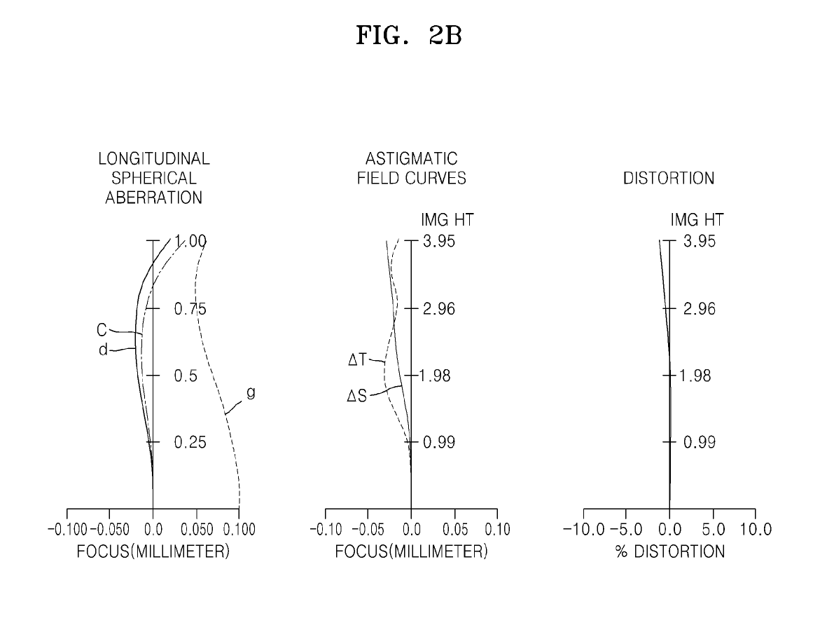

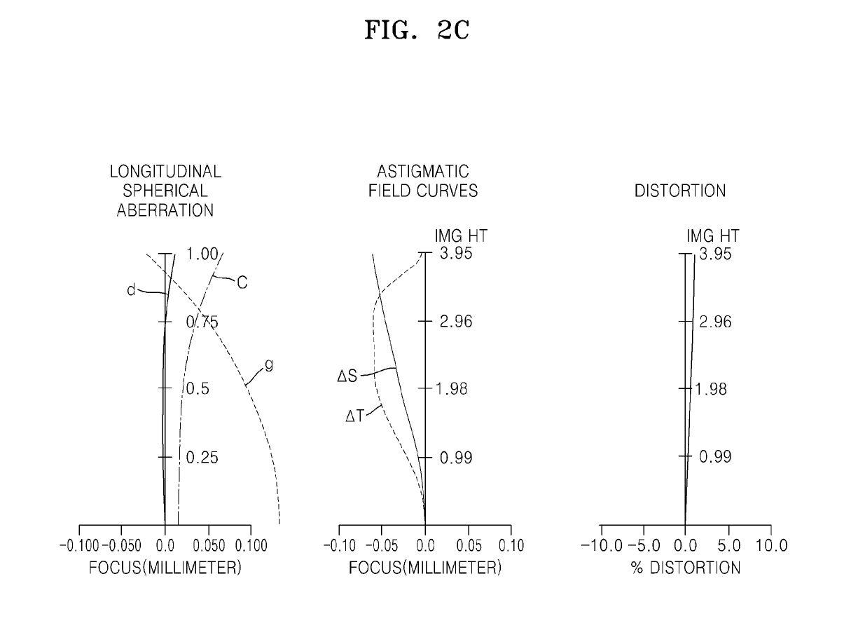

FIGS. 2A, 2B, and 2C are views illustrating longitudinal spherical aberration, astigmatic field curves, and distortion at the wide angle position, the middle position, and the telephoto position of the zoom lens according to the first embodiment of the invention, respectively.

In the graphs illustrating the longitudinal spherical aberration, a vertical axis denotes a ratio with respect to Fno, a line C denotes aberration at a wavelength of about 656.27 nm, a line d denotes aberration at a wavelength of about 587.56 nm, and a line g denotes aberration at a wavelength of about 486.13 nm. In the graphs illustrating the astigmatic aberration, a vertical axis denotes the amount of image, and T and S denote curvatures on a tangential surface and a sagittal surface, respectively.

### Second Embodiment

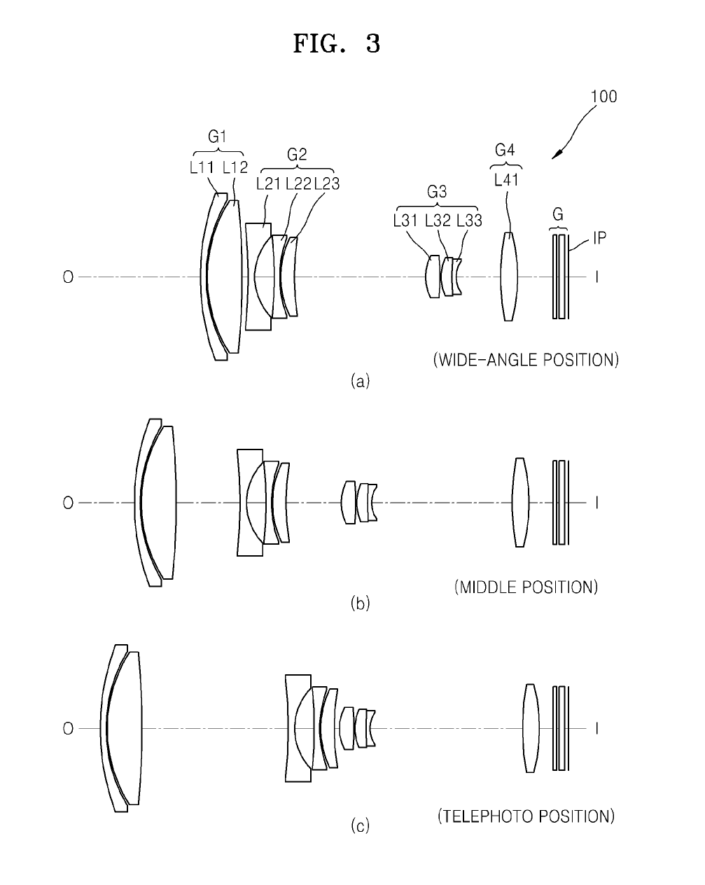

FIG. 3 is an optical arrangement view of a zoom lens according to a second embodiment of the invention. A first lens group G1 includes a first lens L11 that is a negative lens having a meniscus shape and a positive lens L12 having an aspherical surface. A second lens group G2 includes a negative lens L21 having an aspherical surface, a negative lens L22, and a positive lens L23. A third lens group G3 includes a positive lens L31 having an aspherical surface and a doublet lens in which a positive lens L32 and a negative lens L33 are bonded to each other. A fourth lens group G4 includes a positive lens L41. An optical block G is disposed between the fourth lens group G4 and an image plane IP.

FIG. 3A shows a lens at a wide angle position, FIG. 3B shows a lens at a middle position, and FIG. 3C shows a lens at a telephoto position.

In the following tables, during zooming according to the second embodiment, an F-number Fno, a focal length f, a half angle ω, and a variable distance D between lenses will be provided.

TABLE 4

| | Wide angle | Middle | Telephoto |
|---|---|---|---|
| Fno | 3.17 | 5.39 | 5.68 |
| f | 5.02 | 16.51 | 47.14 |
| ω | 38.22 | 13.45 | 4.79 |
| D1 | 0.52 | 6.46 | 15.05 |
| D2 | 13.61 | 5.77 | 0.50 |
| D3 | 4.61 | 14.46 | 15.75 |
| D4 | 3.68 | 2.73 | 1.68 |

Table 2 below shows design data according to the second embodiment.

TABLE 5

| Lens surface | R | D | Nd | νd |
|---|---|---|---|---|
| 1 | 21.965 | 0.60 | 1.84666 | 23.78 |
| 2 | 14.564 | 0.10 | | |
| 3* | 13.024 | 3.70 | 1.58313 | 59.04 |
| 4* | −60.849 | D1 | | |
| 5* | −200.000 | 0.70 | 1.80470 | 40.93 |
| 6* | 5.617 | 2.08 | | |
| 7 | −33.028 | 0.50 | 1.59282 | 68.62 |
| 8 | 10.965 | 0.10 | | |
| 9 | 8.573 | 1.39 | 2.00272 | 19.32 |
| 10 | 20.452 | D2 | | |
| 11* | 4.700 | 1.50 | 1.60602 | 57.44 |
| 12* | −17.963 | 0.10 | | |
| 13 | 5.855 | 1.11 | 1.59282 | 68.62 |
| 14 | 23.408 | 0.40 | 1.72825 | 28.32 |
| 15 | 3.167 | D3 | | |
| 16* | 18.076 | 1.75 | 1.54410 | 56.11 |
| 17* | −21.663 | D4 | | |
| 18 | Infinity | 0.30 | 1.51680 | 64.20 |
| 19 | Infinity | 0.30 | | |
| 20 | Infinity | 0.50 | 1.51680 | 64.20 |
| 21 | Infinity | | | |

In Table 5, * denotes an aspherical surface. Table 3 below shows an aspherical coefficient according to the embodiment of FIG. 3A. In values of the aspherical coefficients, E-m (m denotes a constant) denotes ×10^{-m}.

TABLE 6

| Lens surface | k | A | B | C | D |
|---|---|---|---|---|---|
| 3 | 0.00000E+00 | −1.53418E−05 | −8.75043E−08 | −3.45887E−10 | 0.00000E+00 |
| 4 | 1.00000E+00 | 9.64390E−06 | 0.00000E+00 | 0.00000E+00 | 0.00000E+00 |
| 5 | −1.00000E+00 | −6.82467E−04 | 3.11332E−05 | −5.75285E−07 | 3.33698E−09 |
| 6 | −7.76855E−01 | −3.32245E−04 | 3.07298E−05 | 8.92208E−07 | 0.00000E+00 |
| 11 | −1.17755E+00 | 5.04746E−04 | −7.68160E−06 | 0.00000E+00 | 0.00000E+00 |
| 12 | 0.00000E+00 | 5.22708E−04 | −1.24281E−05 | 0.00000E+00 | 0.00000E+00 |
| 16 | 1.00000E+00 | 7.26880E−04 | −1.22167E−04 | 7.26073E−06 | −2.00547E−07 |
| 17 | −1.46444E+02 | −4.16615E−04 | −7.33525E−05 | 5.09265E−06 | −1.49368E−07 |

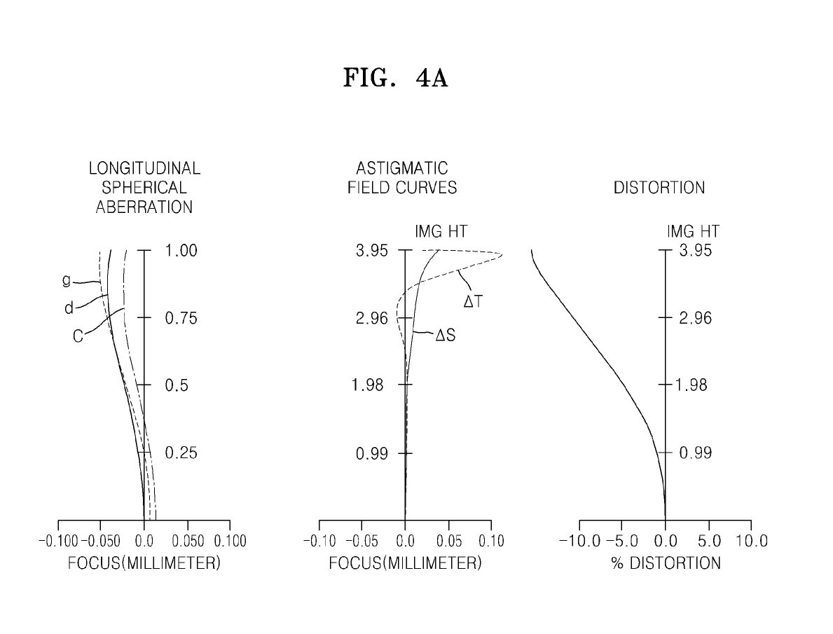

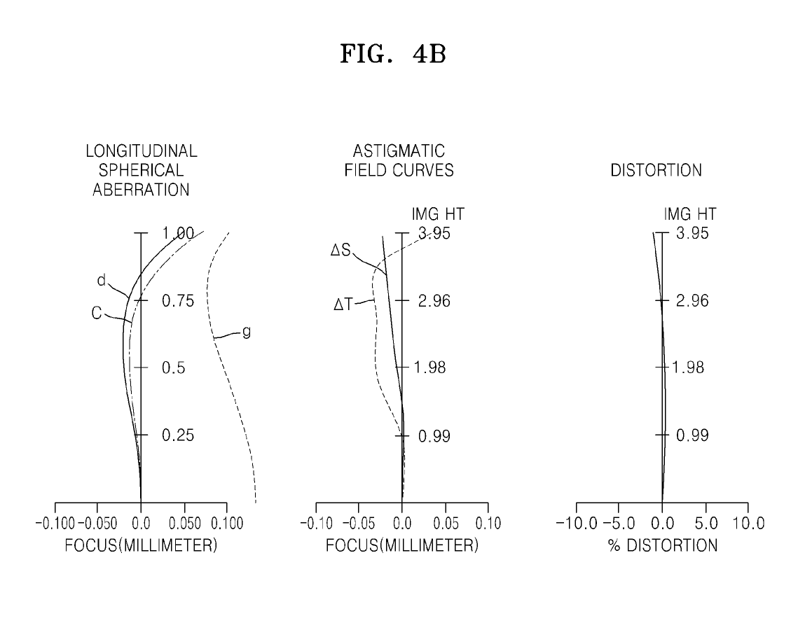

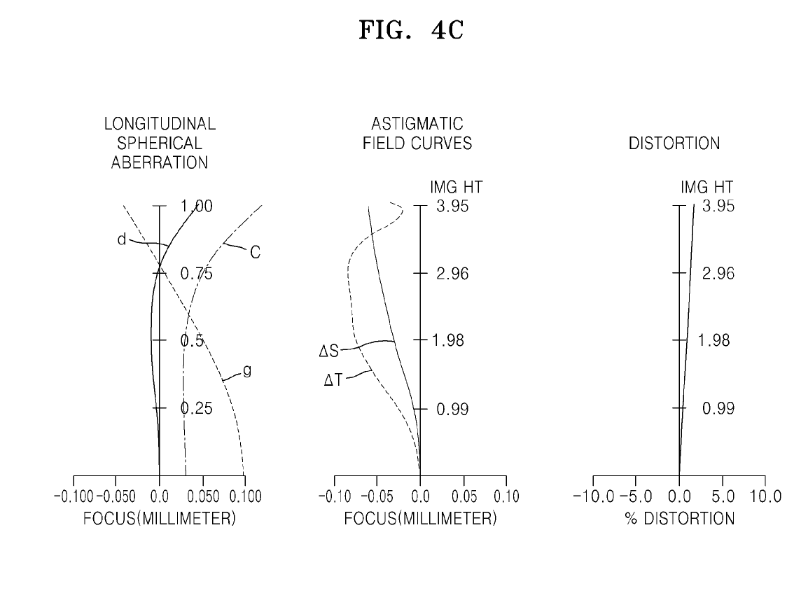

FIGS. 4A, 4B, and 4C are views illustrating longitudinal spherical aberration, astigmatic field curves, and distortion at the wide angle, the middle, and the telephoto position of the zoom lens according to the embodiment of FIG. 1A of the invention, respectively.

In graphs illustrating the longitudinal spherical aberration, the vertical axis denotes a ratio with respect to Fno, a line C denotes aberration at a wavelength of about 656.27 nm, a line d denotes aberration at a wavelength of about 587.56 nm, and a line g denotes aberration at a wavelength of about 486.13 nm. In the graphs illustrating the astigmatic aberration, a vertical axis denotes the amount of image, and T and S denote curvatures on a tangential surface and a sagittal surface, respectively.

### Third Embodiment

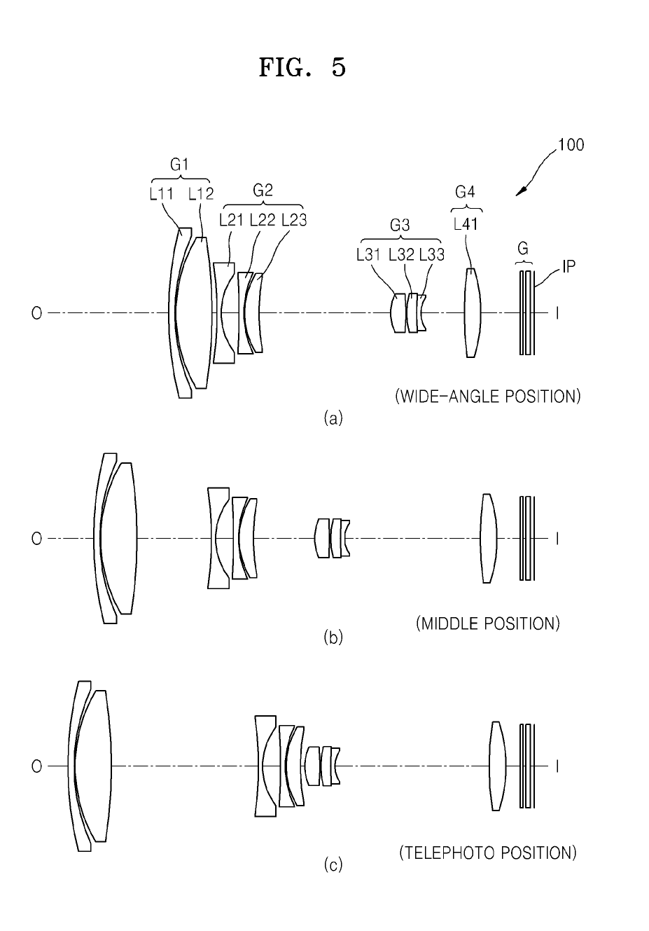

FIG. 5 is an optical arrangement view of a zoom lens according to a third embodiment of the invention. A first lens group G1 includes a first lens L11 that is a negative lens having a meniscus shape and a positive lens L12 having an aspherical surface. A second lens group G2 includes a negative lens L21 having an aspherical surface, a negative lens L22, and a positive lens L23. A third lens group G3 includes a positive lens L31 having an aspherical surface and a doublet lens in which a positive lens L32 and a negative lens L33 are bonded to each other. A fourth lens group G4 includes a positive lens L41. An optical block G is disposed between the fourth lens group G4 and an image plane IP.

FIG. 5A shows a lens at a wide angle position, FIG. 5B shows a lens at a middle position, and FIG. 5C shows a lens at a telephoto position.

In the following tables, during zooming according to the third embodiment, an F-number Fno, a focal length f, a half angle ω, and a variable distance D between lenses will be provided.

TABLE 7

| | Wide angle | Middle | Telephoto |
|---|---|---|---|
| Fno | 3.48 | 5.60 | 6.11 |
| f | 5.00 | 16.51 | 47.96 |
| ω | 38.29 | 13.45 | 4.71 |
| D1 | 0.52 | 7.57 | 15.05 |
| D2 | 13.61 | 6.47 | 0.50 |
| D3 | 4.47 | 13.80 | 15.81 |
| D4 | 4.04 | 2.60 | 1.68 |

Table 3 below shows design data according to the third embodiment.

TABLE 8

| Lens surface | R | D | Nd | νd |
|---|---|---|---|---|
| 1 | 31.914 | 0.60 | 1.84666 | 23.78 |
| 2 | 18.268 | 0.10 | | |
| 3* | 13.750 | 3.70 | 1.58313 | 59.04 |
| 4* | −43.261 | D1 | | |
| 5* | −52.941 | 0.50 | 1.88202 | 37.25 |
| 6* | 6.646 | 1.79 | | |
| 7 | −56.505 | 0.50 | 1.59282 | 68.62 |
| 8 | 8.707 | 0.10 | | |
| 9 | 7.866 | 1.43 | 2.00272 | 19.32 |
| 10 | 19.674 | D2 | | |
| 11* | 4.659 | 1.49 | 1.60606 | 54.97 |
| 12* | −20.036 | 0.10 | | |
| 13 | 5.543 | 1.04 | 1.59282 | 68.62 |
| 14 | 26.281 | 0.40 | 1.72825 | 28.32 |
| 15 | 3.121 | D3 | | |
| 16* | 19.551 | 1.71 | 1.54410 | 56.11 |
| 17* | −19.170 | D4 | | |
| 18 | Infinity | 0.30 | 1.51680 | 64.20 |
| 19 | Infinity | 0.30 | | |
| 20 | Infinity | 0.50 | 1.51680 | 64.20 |
| 21 | Infinity | | | |

In Table 8, * denotes an aspherical surface. Table 9 below shows an aspherical coefficient according to the third embodiment. In values of the aspherical coefficients, E-m (m denotes a constant) denotes ×10^{-m}.

TABLE 9

| Lens surface | k | A | B | C | D |
|---|---|---|---|---|---|
| 3 | 0.00000E+00 | −2.26693E−05 | −1.06206E−07 | −1.87699E−10 | 0.00000E+00 |
| 4 | 1.00000E+00 | 1.86709E−05 | 0.00000E+00 | 0.00000E+00 | 0.00000E+00 |
| 5 | −1.00000E+00 | −5.39559E−04 | 3.05353E−05 | −5.91912E−07 | 2.93776E−09 |
| 6 | −7.49918E−01 | −3.21355E−04 | 3.19226E−05 | 5.15236E−07 | 0.00000E+00 |
| 11 | −1.11461E+00 | 5.77934E−04 | 1.47448E−06 | 0.00000E+00 | 0.00000E+00 |
| 12 | 0.00000E+00 | 6.00489E−04 | −6.68528E−06 | 0.00000E+00 | 0.00000E+00 |
| 16 | 1.18919E+01 | 6.53958E−04 | −1.43338E−04 | 8.52784E−06 | −2.34866E−07 |
| 17 | −8.73004E+01 | −2.28845E−04 | −1.04435E−04 | 7.07144E−06 | −1.90488E−07 |

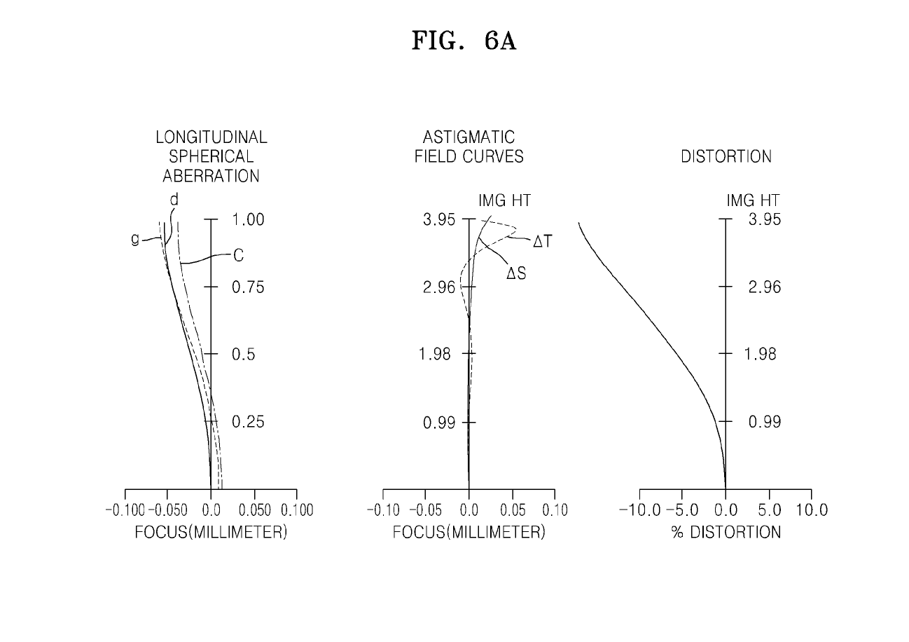

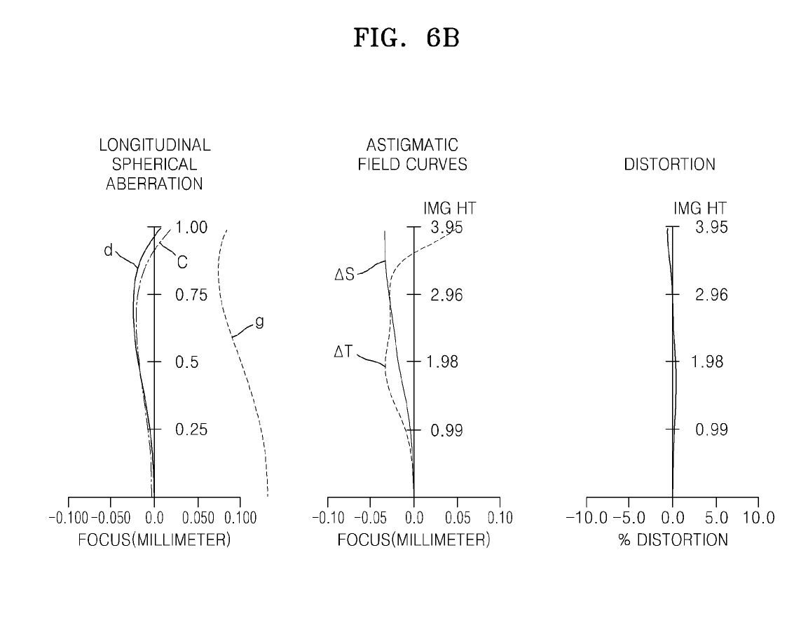

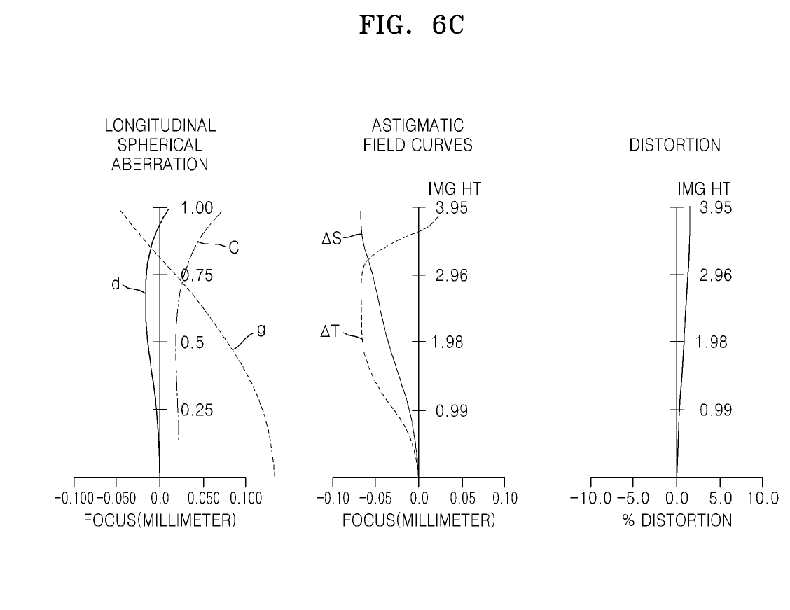

FIGS. 6A, 6B, and 6C are views illustrating longitudinal spherical aberration, astigmatic field curves, and distortion at the wide angle, the middle, and the telephoto position of the zoom lens according to the third embodiment of the invention, respectively.

In graphs illustrating the longitudinal spherical aberration, the vertical axis denotes a ratio with respect to Fno, a line C denotes aberration at a wavelength of about 656.27 nm, a line d denotes aberration at a wavelength of about 587.56 nm, and a line g denotes aberration at a wavelength of about 486.13 nm. In the graphs illustrating the astigmatic aberration, a vertical axis denotes the amount of image, and T and S denote curvatures on a tangential surface and a sagittal surface, respectively.

Table 10 below shows that the embodiments satisfy the above-described conditions.

TABLE 10

| | First embodiment | Second embodiment | Third embodiment |
|---|---|---|---|
| \| β_{3T}/β_{3W} \| | 1.907 | 2.065 | 1.923 |
| T₁/T₃ | 1.136 | 1.156 | 1.159 |
| \| f₂/f_{W} \| | 1.302 | 1.302 | 1.304 |
| fₜ/f_{w} | 9.408 | 9.411 | 9.584 |

The zoom lens according to the embodiments may be suitable for the miniaturization and have superior optical performance while realizing a zoom ratio equal to or greater than about 9×.

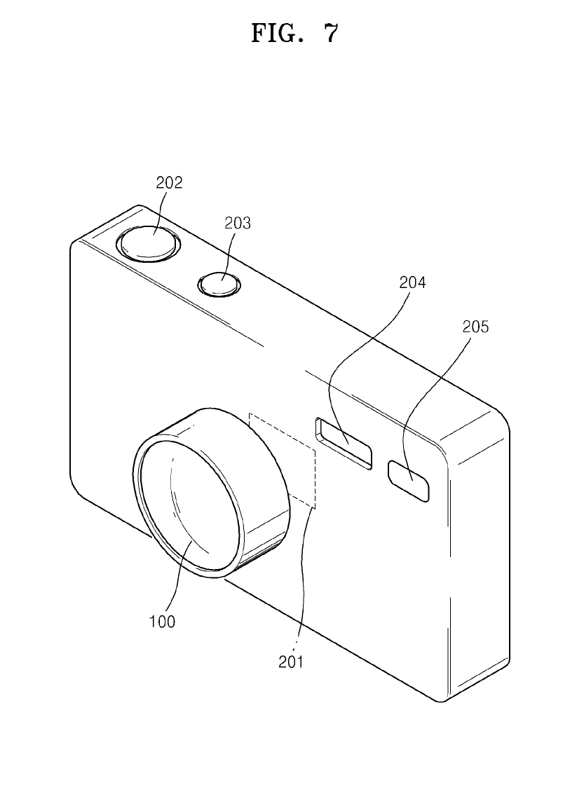

FIG. 7 is a schematic perspective view of a photographing apparatus including a zoom lens 100 according to an embodiment of the invention. The photographing apparatus includes an image pickup device 201 such as a charge-coupled device (CCD) or a complementary metal-oxide semiconductor (CMOS) which receives light from an image formed by the zoom lens 100. A photographing surface of the image pickup device 210 corresponds to an image plane IP of the zoom lens 100. In the case where the photographing apparatus is a film camera, the image plate IP corresponds to a film surface.

The photographing apparatus may include a shutter 202, an on/off button 203, a flash 204 for shooting in dark conditions, a view finder 205 for observing an object to be photographed. Also, the photographing apparatus may further include a recording unit (not shown) in which information corresponding to an object image converted into an electrical signal from the image pickup device 201 and a display unit (not shown) for displaying the object image.

The photographing apparatus converts light received through the image pickup device 201 into an electrical signal to output the signal. Also, the photographing apparatus produces a digital image corresponding to an object to be photographed to record the digital image into a recording medium such as a hard disk drive (HDD), a memory card, an optical disk, a magnetic tape, or the like.

The zoom lens 100 according to the invention may be applied to a photographing apparatus such as a digital camera to obtain bright and high optical performance while realizing high magnification. Also, the photographing apparatus may be miniaturized. The photographing apparatus of FIG. 7 is described only as an example, and thus, the invention is not limited thereto. For example, the zoom lens according to the invention may be applied to various optical instruments other than a camera.

As described above, the zoom lens and the photographing apparatus including the same may realize bright and high optical performance and miniaturization while realizing high magnification.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A zoom lens comprising:
a first lens group having a positive refractive power, a second lens group having a negative refractive power, a third lens group having a positive refractive power, and a fourth lens group having a positive refractive power, that are sequentially arranged from an object side to an image plane side,
wherein the interval between the lens groups adjacent to each other varies when the zoom lens zooms from a wide angle position to a telephoto position, and
wherein the zoom lens satisfies the following inequality:
1.8<|β_{3T}/β_{3W}|<2.2
where β_{3T} denotes the magnification of the third lens group at the telephoto position, and β_{3W} denotes the magnification of the third lens group at the wide angle position.

2. The zoom lens of claim 1, wherein the zoom lens satisfies the following inequality:
0.8<T₁/T₃<1.2
where T₁ denotes the distance the first lens group moves in an optical axis direction when the zoom lens zooms from the wide angle position to the telephoto position, and T₃ denotes the distance the third lens group moves in an optical axis direction when the zoom lens zooms from the wide angle position to the telephoto position.

3. The zoom lens of claim 1, wherein the first lens group comprises a negative lens and a positive lens which are sequentially arranged from the object side to the image plane side, and the positive lens has at least one aspherical surface.

4. The zoom lens of claim 1, wherein the second lens group comprises two negative lenses and a positive lens which are sequentially arranged from the object side to the image plane side, and the negative lens of the object side of the negative lenses has at least one aspherical surface.

5. The zoom lens of claim 1, wherein the zoom lens satisfies the following inequality:
1.2<|f₂/f_{W}|<1.4
where f₂ denotes the focal length of the second lens group, and f_{w} denotes the total focal length at the wide angle position.

6. The zoom lens of claim 1, wherein the zoom lens satisfies the following inequality:
9<fₜ/f_{w}<12
where fₜ denotes the total focal length at the telephoto position, and f_{w} denotes the total focal length at the wide angle position.

7. The zoom lens of claim 1, wherein the third lens group comprises a positive lens having at least one aspherical surface.

8. The zoom lens of claim 1, wherein the third lens group comprises at least one doublet lens comprising a positive lens and a negative lens.

9. The zoom lens of claim 1, wherein the fourth lens group comprises a positive lens having at least one aspherical surface.

10. The zoom lens of claim 9, wherein the positive lens is formed of plastic.

11. The zoom lens of claim 1, wherein the fourth lens group performs focusing.

12. The zoom lens of claim 1, wherein the third lens group is configured to move vertically with respect to the optical axis to perform image blurring compensation.

13. A photographing apparatus comprising:
a zoom lens; and
an image pickup device receiving an image formed through the zoom lens,
wherein the zoom lens comprises: a first lens group having a positive refractive power, a second lens group having a negative refractive power, a third lens group having a positive refractive power, and a fourth lens group having a positive refractive power that are sequentially arranged from an object side to an image plane side, wherein the interval between the lens groups adjacent to each other varies when the zoom lens zooms from a wide angle position to a telephoto position, and
wherein the zoom lens satisfies the following inequality:
1.8<|β_{3T}/β_{3W}|<2.2
where β_{3T} denotes the magnification of the third lens group at the telephoto position, and β_{3W} denotes the magnification of the third lens group at the wide angle position.
